(19) United States
(12) Patent Application Publication
(10) Pub. No.: US 2026/0113177 A1
(43) Pub. Date: Apr. 23, 2026

(54) ELECTRONIC DEVICE, SERVER DEVICE AND METHODS FOR PROVIDING SERVICE THEREOF

(71) Applicant: CRYPTO LAB INC., Seoul (KR)

(72) Inventor: Sunchul Jung, Seoul (KR)

(21) Appl. No.: 19/327,622

(22) Filed: Sep. 12, 2025

(30) Foreign Application Priority Data
Sep. 13, 2024 (KR) 10-2024-0125887
Aug. 19, 2025 (KR) 10-2025-0114969

(51) Int. Cl. H04L 9/00; H04L 9/08; H04L 9/32

(52) U.S. Cl. CPC H04L 9/008; H04L 9/0861; H04L 9/3213

(57) ABSTRACT

An electronic apparatus is disclosed. The electronic apparatus includes a communication interface, a memory, and a processor. The processor generates a public key and a secret key for homomorphic encryption and stores the generated public key and secret key in a memory, when a user prompt is input, divides the user prompt into tokens in preset units, homomorphically encrypts the tokens using a public key, transmits the tokens to a server device storing an encrypted large language model (LLM), when output data of the encrypted LLM is received, decrypts the output data using the secret key, and when the decrypted data corresponds to a control token, transmits the control token to a server device through a communication interface. Accordingly, various LLM services may be provided while maintaining security.

### TECHNICAL FIELD

Apparatuses and methods consistent with the disclosure relate to an electronic apparatus, server device, and methods for providing a homomorphically encrypted service.

### BACKGROUND ART

With the development of an electronic technology, various kinds of electronic apparatuses have been used. Recently, electronic apparatuses often provide services not only on their own but also in conjunction with other devices.

For example, when a server device is provided, various electronic apparatuses accessing the server device may implement various services provided by the server device.

For example, when the electronic apparatus accesses the server device storing a large language model (LLM), users may use a chat service using their electronic apparatuses. Specifically, the users may input various user prompts into their electronic apparatuses' The server device inputs a user prompt into the LLM and provides the output data to the electronic apparatus, and the electronic apparatus may display a response corresponding to output data. Here, the response may be a response to the user prompt input by the user.

To use an LLM-based service, the user prompt input by the user may be transmitted to the server device in the form of plaintext data. In this case, there is a risk of data being leaked by third parties or exposed to an administrator of the server device, etc.

Therefore, the encrypted LLM, which processes data in an encrypted state, has been developed. However, since the encrypted LLM operates on encrypted data, it is not possible to identify intermediate data generated during the operation process, leading to the problem of not being able to determine an end point of an iterative inference process.

Therefore, the need for a technology that may effectively utilize encrypted LLM has arisen.

### DISCLOSURE OF INVENTION

### Solution to Problem

Aspects of the present disclosure provide an electronic apparatus, server device, and method for providing a service thereof capable of providing services based on an encrypted LLM in a homomorphically encrypted state.

In accordance with an aspect of the disclosure, an electronic apparatus includes: a communication interface; a memory; and a processor, in which the processor is configured to generate a public key and a secret key for homomorphic encryption and store the generated public key and secret key in the memory, when a user prompt is input, divide the user prompt into tokens in preset units, homomorphically encrypt the tokens using the public key, transmit the encrypted tokens to a server device storing an encrypted large language model (LLM) through the communication interface, when output data of the encrypted LLM is received from the server device in response to the input of the encrypted token, decrypt the output data using the secret key, and when the decrypted data corresponds to a control token, transmit the control token to the server device through the communication interface.

In accordance with another aspect of the disclosure, a server device includes: a communication interface; a memory storing an encrypted LLM; and a processor, in which the processor is configured to when a public key for homomorphic encryption is received through the communication interface, generate a service instance corresponding to an electronic apparatus transmitting the public key, when tokens homomorphically encrypted by dividing a user prompt input to the electronic apparatus in preset units are received through the communication interface, input at least one of the encrypted tokens to the encrypted LLM to acquire output data, transmit the output data to the electronic apparatus through the communication interface, and when a control token is received from the electronic apparatus through the communication interface, control an operation of the encrypted LLM based on the control token.

In accordance with still another aspect of the disclosure, a method of providing a service of an electronic apparatus includes: generating a public key and a secret key for homomorphic encryption and storing the generated public key and secret key in the memory; when a user prompt is input, dividing the user prompt into tokens in preset units and homomorphically encrypting the tokens using the public key; transmitting the homomorphically encrypted tokens to a server device storing an encrypted large language model (LLM) and receiving output data of the encrypted LLM from the server device in response to the input of the encrypted token; decrypting the received output data using the secret key; and when the decrypted data corresponds to a control token, transmitting the control token to the server device.

In accordance with yet another aspect of the disclosure, a method of providing a service of a server device includes: when a public key for homomorphic encryption is received from an electronic apparatus, generating a service instance corresponding to an electronic apparatus transmitting the public key; when a user prompt input to the electronic apparatus is divided in preset units and then homomorphically encrypted tokens are received, inputting at least one of the encrypted tokens to an encrypted LLM to acquire output data; transmitting the output data to the electronic apparatus; and when a control token is received from the electronic apparatus, controlling an operation of the encrypted LLM based on the control token.

According to various embodiments of the present disclosure, it is possible to provide the user's desired service by appropriately using the encrypted LLM that processes data in the homomorphically encrypted state.

### BRIEF DESCRIPTION OF DRAWINGS

The above and/or other aspects of the disclosure will be more apparent by describing certain embodiments of the disclosure with reference to the accompanying drawings, in which:

FIG. 1 is a schematic diagram for describing operations of an electronic apparatus and a server device according to at least one embodiment of the present disclosure;

FIG. 2 is a block diagram illustrating configurations of each of the electronic apparatus and server device according to at least one embodiment of the present disclosure;

FIG. 3 is a diagram for describing a case where the electronic apparatus according to at least one embodiment of the present disclosure provides a chat service;

FIG. 4 is a flowchart for describing a method for providing a service of an electronic apparatus according to at least one embodiment of the present disclosure;

FIG. 5 is a flowchart for describing a method for providing a service of a server device according to at least one embodiment of the present disclosure; and

FIGS. 6 and 7 are timing diagrams for describing the operations of the electronic apparatus and the server device according to at least one embodiment of the present disclosure.

### MODE FOR INVENTION

In the present disclosure, an information (data) transmission process performed may be encrypted/decrypted as necessary, and expressions describing the information (data) transmission process in the present disclosure and the claims should be interpreted as including cases in which encryption/decryption is performed, even if not separately mentioned.

In the present disclosure, expressions such as “transmission (delivery) from A to B” or “A receiving from B” include transmission (delivery) or reception with another medium included therebetween, and do not necessarily express only what is directly transmitted (delivered) or received from A to B.

In the description of the present disclosure, the order of each step should be understood as non-limiting unless the preceding step needs to be logically and temporally performed necessarily before the following step. In other words, except for the above exceptional cases, even if the process described as the following step is performed before the process described as the preceding step, the nature of the disclosure is not affected, and the scope should also be defined regardless of the order of the steps. In this specification, “A or B” is defined to mean not only selectively indicating either one of A and B, but also including both A and B.

In addition, in the present disclosure, the term “include” has a meaning encompassing further including other components in addition to elements listed as included.

In this disclosure, only essential components necessary for the description of the present disclosure are described, and components unrelated to the essence of the present disclosure are not mentioned. In addition, it should not be interpreted as an exclusive meaning that includes only the mentioned components, but should be interpreted as a non-exclusive meaning that may include other components.

In the present disclosure, the term “value” is defined as a concept that includes not only a scalar value but also forms such as a vector or a polynomial.

Mathematical operations and calculations of each step of the present disclosure to be described below may be implemented as computer operations by the known coding method and/or coding designed to suit the present disclosure.

Specific equations to be described below are illustratively described among possible alternatives, and the scope of the present disclosure should not be construed as being limited to equations mentioned in the present disclosure.

For convenience of description, in the present disclosure, a notation is defined as follows.
a←D: select element (a) according to distribution (D)
s1, s2 ∈R: S1, S2: Each of S1 and S2 is an element belonging to set R.
mod(q): Modular operation with element q
[⋅]: Round-off internal value

Hereinafter, various embodiments of the present disclosure will be described in detail with reference to the accompanying drawings.

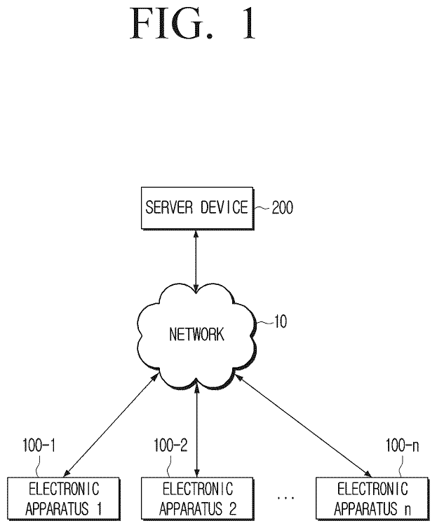

FIG. 1 is a schematic diagram for describing operations of an electronic apparatus and a server device according to at least one embodiment of the present disclosure. Referring to FIG. 1, a plurality of electronic apparatuses 100-1 to 100-n may communicate with a server device 200 via a network 10.

The network 10 may be implemented as various types of wired/wireless communication networks, broadcast communication networks, optical communication networks, cloud networks, etc. FIG. 1 illustrates a state in which each electronic apparatus 100-1 to 100-n is connected to a single server device 200 via the network 10, but the present disclosure is not limited thereto. Each electronic apparatus may also be directly connected to the server device 200 via a method such as Wi-Fi, Bluetooth, or near field communication (NFC) without a separate intermediary.

FIG. 1 illustrates a single server device 200, but at least one server device 200 may be implemented, and may be implemented as a web server or cloud server connectable to the Internet.

The server device 200 provides various services using the encrypted large language model (LLM). For example, the server device 200 may provide a chat service.

The chat service is a service in which the server device 200 provides responses to messages input by the user on their own electronic apparatus, thereby continuing the conversation. During the conversation, when the user makes a search or translation request, the server device 200 may also provide search services, translation services, etc., corresponding to the request.

In this disclosure, the encrypted large language model (LLM) refers to an artificial intelligence model that operates on data in a homomorphically encrypted state and provides results that meet user requests. Although it may be variously referred to as a secure artificial intelligence model, a privacy-preserving model, a secret model, etc., it is referred to as the encrypted large language model (LLM) in this disclosure.

The electronic apparatuses 100-1 to 100-n may be various terminal devices used by various users. Specifically, the electronic apparatuses 100-1 to 100-n may be implemented in various forms, such as PCs, laptop PCs, mobile phones, tablet PCs, kiosks, TVs, home servers, other electronic apparatuses equipped with IoT functionality, and game players.

A user may access the server device 200 using their electronic apparatus (hereinafter referred to as “100”) and transmit arbitrary data to the server device 200. When using the chat service described above, the user may transmit text data.

In this case, when the contents input by the user are transmitted in the form of plaintext data, there is a risk of the data being hacked during the transmission process or being intentionally or accidentally exposed by the administrator of the server device 200.

Therefore, in various embodiments of the present disclosure, the electronic apparatus 100 homomorphically encrypts contents input by a user and transmits the contents to the server device 200. The server device 200 inputs the homomorphically encrypted data into the encrypted LLM and then returns the output data to the electronic apparatus 100. Since the encrypted LLM provides output data through operations on homomorphic ciphertext, the output data also becomes the form of the homomorphic ciphertext. Therefore, even if an administrator of the server device 200 checks the contents input by the user, i.e., the user prompt or output data, the contents may not be identified. Consequently, the user may utilize the chat services, etc. while maintaining the security of the service. For example, the user may check the response message corresponding to the message input through the user's own electronic apparatus 100.

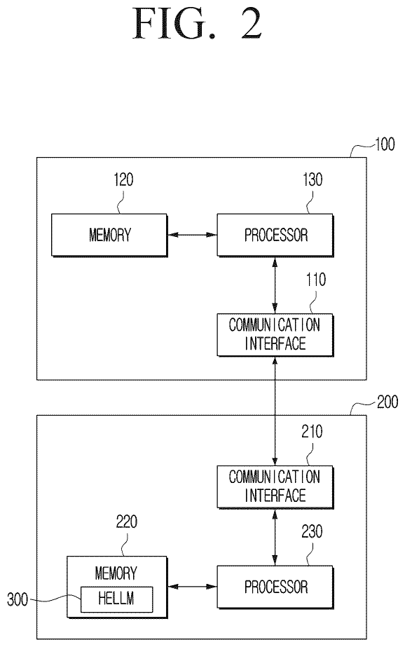

FIG. 2 is a block diagram illustrating configurations of each of the electronic apparatus and server device according to at least one embodiment of the present disclosure.

Referring to FIG. 2, an electronic apparatus 100 according to at least one embodiment of the present disclosure includes a communication interface 110, memory 120, and a processor 130. As described above, the electronic apparatus 100 may be implemented in various forms, and thus, various detailed components may be added. For example, when implemented as a mobile phone, the electronic apparatus 100 may further include a display, a touch sensor, a speaker, a power circuit, and the like.

The communication interface 110 is a component for communicating with various external devices, including the server device 200. The communication interface 110 may transmit and receive various signals and data to and from external devices through various wired and wireless communication methods, such as wired/wireless local area network (LAN), wide area network (WAN), Ethernet, IEEE 1394, Bluetooth, AP-based Wi-Fi (wireless LAN network), Zigbee, high-definition multimedia interface (HDMI), universal serial bus (USB), mobile high-definition link (MHL), audio engineering society/European broadcasting union (AES/EBU), optical, and coaxial. The communication interface 110 may also be referred to as a communication unit or a communication module.

The memory 120 is configured to store various programs, data, instructions, etc. required for the operation of the electronic apparatus 100. The memory 120 may be implemented as at least one of various memories, such as dynamic RAM, static RAM (SRAM), synchronous dynamic RAM (SDRAM), one-time programmable ROM (OTPROM), programmable ROM (PROM), erasable and programmable ROM (EPROM), electrically erasable and programmable ROM (EEPROM), mask ROM, flash ROM, flash memory, a hard drive, or a solid state drive (SSD).

The memory 120 may store a client application for operation in conjunction with the encrypted LLM. Furthermore, depending on the type of services to be provided, a customized preprocessing module may be stored in memory 120. Specifically, a customized tokenizer, an embedding module, and the like may be stored. Furthermore, the memory 120 may store a token set corresponding to the service type. This token set may be referred to as dictionary data. The token set may be updated from time to time or periodically.

The processor 130 is a component for controlling a general operation of the electronic apparatus 100. The processor 130 may perform various operations based on commands, programs, data, etc., stored in the memory 120.

The processor 130 may be implemented by a digital signal processor (DSP) or a microprocessor, that processes a digital signal. However, the processor 130 is not limited thereto, but may include one or more of a central processing unit (CPU), a micro controller unit (MCU), a micro processing unit (MPU), a controller, an application processor (AP), a communication processor (CP), and an ARM processor, or an artificial intelligence (AI) processor, or may be defined by these terms. In addition, the processor 130 may be implemented by a system-on-chip (SoC) or a large scale integration (LSI) in which a processing algorithm is embedded, or may be implemented in the form of a field programmable gate array (FPGA). The processor 130 may perform various functions by executing computer executable instructions stored in the memory 120.

Specifically, when a user input message is received through various input means, such as a touchscreen, camera, or microphone, the processor 130 may perform the homomorphic encryption on the input message to acquire the homomorphic ciphertext. The input message may include various data, such as text, multimedia data such as photos or videos, image data, and programs. The input message is the form of the plaintext data, and after the homomorphic encryption, is converted into the homomorphically encrypted message. The homomorphically encrypted message is referred to as the homomorphic ciphertext in this disclosure.

In FIG. 2, the communication interface 110, the memory 120, and the processor 130 are each illustrated as one, but the number of these elements may vary.

According to various embodiments of the present disclosure, the electronic apparatus 100 may transmit the homomorphic ciphertext obtained by homomorphically encrypting data.

The homomorphic ciphertext may be generated by encrypting a plaintext message using a public key. When decrypted using a secret key, the homomorphic ciphertext may be generated in the form that satisfies the following properties.

$$Dec ( ct , sk ) = < c t , s k > = M + e ( mod q ) \qquad < Equation 1 >$$

Here, <, > denotes a usual inner product, ct denotes a ciphertext, sk denotes a secret key, M denotes a plaintext message, e denotes an encryption error value, and mod q denotes a modulus of the ciphertext. q should be selected to be greater than a result value M obtained by multiplying a scaling factor Ä by a message. When an absolute value of the error value e is sufficiently small compared to M, a decryption value M+e of the ciphertext is a value that may replace the original message with the same precision in significant figure operation. Among the decrypted data, an error may be arranged on the least significant bit (LSB) side, and M may be arranged on the next least significant bit side.

To perform the homomorphic encryption, the public key and the secret key are required. The processor 130 may generate and use a public key required to perform encryption by itself, or may receive and use the public key from an external device. For example, another terminal device performing decryption may generate the public key and the secret key, respectively, and then distribute the public key to other devices.

A method for generating a public key and a secret key may be implemented variously. For example, the processor 130 may generate the public key using a Ring-LWE technique. Specifically, the processor 130 may first set various parameters and rings and store the parameters and rings in the memory 120. Examples of the parameters may include lengths of plaintext message bits, sizes of public and secret keys, and the like.

The ring may be represented by the following equation.

$$R = {Z}_{q} [ x ] / ( f ( x ) ) \qquad < Equation 2 >$$

Here, R denotes a ring, Zq denotes a coefficient, and f(x) denotes an n-th polynomial.

The ring is a set of polynomials having predetermined coefficients, and means a set in which addition and multiplication are defined between elements and which is closed for addition and multiplication.

For example, the ring means a set of n-th polynomials having a coefficient Zq. Specifically, when n is Φ (N), it means an N-th cyclotomic polynomial. f(x) denotes ideal of Zq[x] generated by the f(x). The Euler totient function Φ(N) means the number of natural numbers that is coprime to N and smaller than N. When Φ_{N}(x) is defined as an N-th cyclotomic polynomial, the ring may also be represented by Equation 3 as follows.

$$R = {Z}_{q} [ x ] / {Φ}_{N} ( x ) ) \qquad < Equation 3 >$$

The ring of the above-described Equation 3 may have complex numbers in the plaintext space. Meanwhile, in order to improve the operation speed of the homomorphic ciphertext, only a set in which the plaintext space is a real number in the above-described set of rings may be used.

When such a ring is set, the processor 130 may calculate the secret key sk from the ring.

The secret key sk may be represented as follows.

$$sk ← ( 1 , s ( x ) ) , s ( x ) ∈ R \qquad < Equation 4 >$$

Here, s(x) means a polynomial generated randomly with small coefficients.

The processor 130 may calculate a first random polynomial a(x) from the ring. The first random polynomial may be represented as follows.

$$a ( x ) ← R \qquad < Equation 5 >$$

Also, the processor 130 may calculate an error. Specifically, the processor 130 may extract an error from a discrete Gaussian distribution or a distribution statistically close to the discrete Gaussian distribution. This error may be represented as follows.

$$e ( x ) ← {D}_{α q}^{n} \qquad < Equation 6 >$$

When an error is calculated, the processor 130 may calculate a second random polynomial by performing modular operation on the error in the first random polynomial and the secret key. The second random polynomial may be represented as follows.

$$b ( x ) = - a ( x ) s ( x ) + e ( x ) ( mod q ) \qquad < Equation 7 >$$

Finally, a public key pk is set as follows in a form including the first random polynomial and the second random polynomial.

$$p k = ( b ( x ) , a ( x ) ) \qquad < Equation 8 >$$

Since the above-described key generation method is only an example, it is not necessarily limited thereto, and it goes without saying that the public key and the secret key may be generated by other methods.

The processor 130 stores the generated public and secret keys in the memory 120. Since these keys are used for the homomorphic encryption, they may be collectively referred to as homomorphic encryption keys. In addition to the public and secret keys described above, the homomorphic encryption keys may also include an operation key used when performing the operation in the homomorphic ciphertext state. The operation key may include a rotation key, a multiplication key, an addition key, etc. Various embodiments of the present disclosure have been described based on a Cheon-Kim-Kim-Song (CKKS) scheme among the homomorphic encryption schemes. However, the homomorphic encryption scheme is not limited to this scheme, and various schemes such as Brakerski-Gentry-Vaikuntanathan (BGV), Brakerski-Fan-Vercauteren (BFV), Fully Homomorphic Encryption over the Torus (FHEW), and the Torus Fully Homomorphic Encryption (TFHE) scheme may be used.

The processor 130 may transmit the generated public key or operation key to the server device 200 via the communication interface 110.

When the user wishes to use the encrypted LLM held by the server device 200, the user may input the user prompt. In various embodiments of the present disclosure, the user prompt may be a sentence, a question, etc., input to the encrypted LLM. The user prompt may be described in various ways, such as an input message, input data, or input prompt, but is referred to as a user prompt hereinafter.

When the user prompt is input, the processor 130 tokenizes the user prompt. In the present disclosure, the tokenizing may refer to the process of breaking down the user prompt input by the user into smaller units (e.g., tokens) for processing by the AI model. The token may be defined as various units, such as words, symbols, or syllables. Since the encrypted LLM is an AI model for processing the tokens in the homomorphically encrypted state, the processor 130 performs the homomorphic encryption on each token using the public key stored in the memory 120. The homomorphic ciphertext corresponding to each token is referred to as the encrypted token in the present disclosure. The encrypted token may be in the form of an embedding vector.

When the user prompt is divided into multiple tokens, the processor 130 may assign physical location information to each embedding vector. Accordingly, the encrypted LLM may numerically recognize a sort order of each encrypted token. Furthermore, the processor 130 may normalize and then transmit the embedding vector corresponding to each encrypted token.

The processor 130 transmits the encrypted token to the server device 200 via the communication interface 110. When the user prompt is continuously input, the processor 130 may tokenize and homomorphically encrypt the user prompt portion input until that point and stream the encrypted token to the server device 200.

The server device 200 inputs the encrypted token transmitted from the electronic apparatus 100 to the encrypted LLM and transmits the output data to the electronic apparatus 100. The output data may be the homomorphic ciphertext corresponding to a response to the input user prompt. The response may be a probability value for at least one message.

When receiving the output data, the processor 130 decrypts the output data using the secret key. In this disclosure, this decryption may be referred to as homomorphic decryption.

The homomorphic decryption is the process of converting the homomorphic ciphertext into plaintext. Assuming the CKKS method, the processor 130 applies a secret key sk to the homomorphic ciphertext ct=(c0, c1) to generate a message polynomial D(c, sk)=c0+c1sk, and then scales the message polynomial D(c, sk) by applying the scaling factor Ä to restore an approximate message M′ for an original message M. Thereafter, the processor 130 performs an inverse Fourier transform to restore the original vector message.

The restored message may include a general token and a control token corresponding to the user prompt. The general token may be a token containing a response message. The general token may also be referred to as a response token or a non-control token.

The control token is a token used in the LLM to control the operation or output format of the model. The control token may include various tokens for controlling output style, language, format, attitude, role, termination, etc.

The processor 130 may identify the token corresponding to the decrypted data based on the dictionary data stored in the memory 120. The dictionary data may be data organized based on various available tokens.

When the decrypted data corresponds to the control token, the processor 130 transmits the control token to the server device 200 via the communication interface 110.

Therefore, the server device 200 may provide the output data of the encrypted LLM to the electronic apparatus 100 in a state where the contents of the user prompt are unknown, and receive the control token transmitted from the electronic apparatus 100 to perform the control operation corresponding to the control token.

The control token may include various tokens, such as an end of sequence (EOS) token, an LLM branch token, a content processing control token, and a control token for structural control and context separation. The EOS token is a special token indicating signals that the sequence (e.g., a sentence, document, etc.) is terminated. When the user prompt is “Hello, How are you?”, the token might be composed of “Hello”, “,”, “How”, “are”, “you”, “?”, or “<EOS>”. The output data of the encrypted LLM will also include an EOS token at the end of the sequence.

The LLM branch token may include the control tokens, such as <code> and </code>, to indicate the start and end of a code block. When these control tokens are input, the encrypted LLM may execute a sub-module for code writing to process data. Additionally, the control token may be used to execute the sub-module for code writing for each programming language, or to specify the user desired output language in a multilingual language model, such as the [LANG] token.

The content processing control token may be a token that indicates image insertion, such as <img> and </img>, or a control token that indicates the insertion of a drawing or diagram into the output, such as [DRAW]. When the control token is input, the encrypted LLM may branch to the image generation model.

Examples of control tokens for structural control and context separation include [Context Switch] and [Task:]. [Context Switch] is a control token that indicates a context switch. When [Context Switch] is input, the encrypted LLM changes the current context or switches to a new topic. [Task:] is a control token for indicating a specific natural language-based downstream task. For example, when [Task: Summarize] is input, the encrypted LLM executes a sub-module for performing a summary service. When [Task: Translate] is input, the encrypted LLM executes a sub-module for providing a translation service along with the [LANG] token.

In addition to these examples, a service provider may construct various generative model pipelines and define a dedicated control token to train each model. The control token is identified by the processor 130 of the electronic apparatus 100 and transmitted to the server device 200. Accordingly, the server device 200 may accurately identify the contents of the control token and perform the corresponding control operation even in the process of inputting and processing the homomorphically encrypted user prompt to the encrypted LLM. For example, when the EOS token is transmitted from the electronic apparatus 100, the server device 200 may determine that the response to the user prompt has been completed and terminate the use of the encrypted LLM.

Referring to FIG. 2, the server device 200 includes a communication interface 210, a memory 220, and a processor 230. The memory 220 stores an encrypted LLM 300. The encrypted LLM 300 is an artificial intelligence model for processing the homomorphic ciphertext, and may also be referred to a homomorphically encrypted large language model (HELLM).

The communication interface 210 is a component for performing communication with various external devices, including the electronic apparatus 100.

The memory 220 may store the encrypted LLM 300. The general LLM transformer architecture is composed of a multi-head attention mechanism and a feed-forward neural network.

The multi-head attention mechanism performs query, key, value (QKV) interpretation on the user prompt composed of the tokens in the form of an embedding vector. Here, the query represents the relationship between the tokens, the key represents the token's attribute, and the value represents the actual contents of the token.

The LLM calculates the correlation (or token attention) between the tokens by taking the inner product of Q and K. The result value is then converted into a probability distribution using the softmax function. The LLM weights this probability distribution to generate a new vector, which is then transmitted to the next layer.

Once the attention operation as described above is completed, the feed-forward neural network passes each token through independent neural networks. This process may assign flexibility and nonlinearity to the model.

The LLM performs a decoding process of predicting the next token based on the output of the attention mechanism and the output of the feed-forward neural network. This prediction is performed recursively by feeding back with the previous output as input and continues until the sentence is completed.

The encrypted LLM 300 is an artificial intelligence model designed to perform the structure and operation of the LLM described above on homomorphic ciphertext. For example, when the encrypted LLM 300 is designed to process the homomorphic ciphertext of the CKKS scheme, the encrypted LLM 300 reconstructs unit operations, which constitute the LLM graph, into a CKKS homomorphic operation circuit. The encrypted LLM 300 may receive and infer the user prompt in the encrypted state.

The encrypted LLM 300 may include a configuration configured to encode weights of a pre-trained language model into CKKS plaintexts, a configuration configured to encrypt a user input, i.e., a user prompt provided in the form of a position-embedded vector, a configuration configured to implement a ciphertext-plaintext matrix multiplication algorithm between a homomorphic ciphertext containing a user prompt and a pre-trained QKV weight tensor or feed-forward weight tensor, a configuration configured to implement an algorithm that approximates nonlinear functions such as softmax or activation functions, which take ciphertexts resulting from ciphertext-plaintext matrix multiplication as inputs, by using a CKKS homomorphic operation circuit, a configuration configured to implement a ciphertext-ciphertext matrix multiplication algorithm among ciphertexts that are results of ciphertext-plaintext matrix multiplication, a configuration configured to perform matrix-vector multiplication between a ciphertext tensor and a ciphertext vector, a configuration configured to perform one-hot encoding for a generated encrypted token, a configuration configured to perform location embedding that adds positional information to a vector, etc.

Some of the components of the encrypted LLM 300 may be embedded in the application of the electronic apparatus 100. For example, the configuration for encrypting the user prompt, the configuration for performing one-hot encoding, the configuration for performing location embedding, etc., may be installed in the memory 120 of the electronic apparatus 100.

In addition to the encrypted LLM 300, the memory 120 of the server device 200 may store various programs, data, instructions, etc., necessary for the operation of the server device 200. The encrypted LLM 300 need not be stored within the server device 200 and may be stored in the external device connected to the server device 200.

The processor 230 is a configuration for performing operations according to various embodiments of the present disclosure based on the programs, data, instructions, etc., stored in the memory 200.

The communication interface 210, memory 220, and processor 230 of the server device 200 may also be implemented as at least one component, similar to the electronic apparatus 100. The general operation and examples of each configuration have been specifically described in the description of the electronic apparatus 100, so a detailed description thereof will be omitted.

The processor 230 may receive various data, such as public keys or operation keys for homomorphic encryption, through the communication interface 210. In addition to the key data, the electronic apparatus 100 may also transmit various information, such as its IP address, user account information, and password.

The processor 230 may generate a service instance corresponding to the electronic apparatus that has transmitted the data. The service instance may be a task that generates a service environment for a user accessing the server device 200 and allocates resources to implement the service environment.

When the user prompt input to the electronic apparatus 100 is divided into preset units as described above, homomorphically encrypted, and then transmitted in the form of the encrypted tokens, the processor 230 may receive these encrypted tokens via the communication interface 210.

The processor 230 inputs at least one of the received encrypted tokens to the encrypted LLM 300, obtains output data, and transmits the output data to the electronic apparatus 100 via the communication interface 210.

As described above, the electronic apparatus 100 performs an operation to display a response based on the general token, rather than the control token. Conversely, when the control token is identified, the electronic apparatus 100 may transmit the control token.

When the processor 230 receives the control token from the electronic apparatus 100 via the communication interface 210, the processor 230 controls the operation of the encrypted LLM based on the control token.

Specifically, when the control token received from the electronic apparatus 100 is the end of sequence (EOS) token, the processor 230 may terminate the use of the encrypted LLM 300. Until the EOS token is received, the processor 230 may perform an operation of sequentially inputting the encrypted tokens to the encrypted LLM and an operation of feeding back the output data thereof to the encrypted LLM. The processor 230 may repeat these operations at least once until the EOS token is received.

Meanwhile, when the control token other than the EOS token, for example, the token for operation control, is received, the processor 230 may execute and provide the service corresponding to the control token. Specifically, the processor 230 may control the operation of the encrypted LLM based on the contents of the control token. For example, the encrypted LLM may include multiple generation models distinguished according to various criteria, such as by language, programming language, or content. The processor 230 may selectively branch multiple generation models based on the contents of the control token to acquire the output data.

For example, when the control token such as <code> and </code> is identified, the processor 230 may set the encrypted LLM to execute the sub-module for code writing.

Alternatively, when the control token such as <img>, </img>, and [DRAW] is identified, the processor 230 may set the encrypted LLM to branch to the image generation model.

Alternatively, when [Context Switch] is identified, the processor 230 may set the encrypted LLM to switch the context, when [Task: Summarize] is identified, the processor may set the encrypted LLM to execute the sub-module for summarization, and when [Task: Translate] is identified, the processor may set the encrypted LLM to execute the sub-module for translating into a language corresponding to a [LANG] token.

Meanwhile, as described above, in order to identify the control token in the electronic apparatus 100, data regarding the token should be stored in advance in the electronic apparatus 100. The server device 200 may share various control tokens and handlers with the electronic apparatus 100 depending on the type of service provided.

For example, the processor 230 may compile the injection code for injecting the control token and handler into the electronic apparatus 100 and transmit the injection code to the electronic apparatus 100 via the communication interface 210.

The handler may be a function or interface connected to enable the encrypted LLM to call an external function.

The injection code is code generated by the encrypted LLM to transmit the control token and handler to the external electronic apparatus 100. When the processor 130 of the electronic apparatus 100 receives the injection code via the communication interface 110, the processor 130 stores the control token and handler in the memory 120 based on the injection code. Accordingly, various token data (e.g., token ID), server command ID, handler data, etc., usable for the corresponding service may be stored. The control token ID, the handler ID, etc., may be registered in the vector form in the execution table stored in the memory 120.

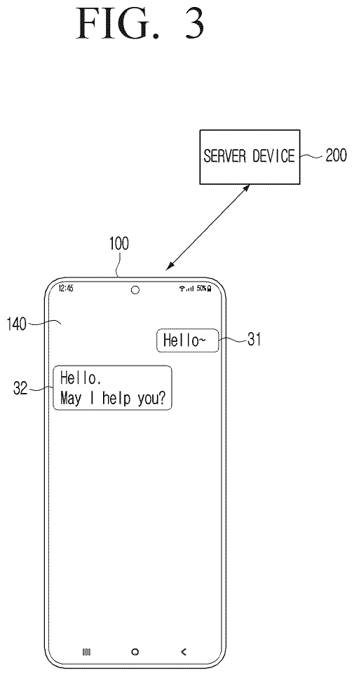

FIG. 3 is a diagram illustrating a case where the chat service provided by encrypted LLM is displayed on the electronic apparatus according to at least one embodiment of the present disclosure.

FIG. 3 illustrates an electronic apparatus 100 implemented as a mobile phone, but as described above, the type of electronic apparatus 100 is not limited thereto and may be implemented in various ways.

The electronic apparatus 100 performs tokenization and homomorphic encryption on the user prompt “Hello-” input by the user and transmits at least one encrypted token to the server device 200. The electronic apparatus 100 separately controls the display 140 to display the user prompt input by the user.

The display 140 is configured to display various screens under the control of the processor 130. Depending on the type of electronic apparatus 100, the display 140 may be implemented in various forms, such as a liquid crystal display (LCD), an organic light emitting diodes (OLED) display, a light emitting diodes (LED) display, a micro LED display, a mini LED display, a quantum dot (QD) display, and a quantum dot light-emitting diodes (QLED) display. Although FIG. 3 illustrates the electronic apparatus 100 with a built-in display 140, the electronic apparatus 100 is not necessarily limited thereto. The electronic apparatus 100 may also be implemented as a PC connected to an external display, such as a monitor or TV.

The server device 200, which receives at least one encrypted token corresponding to the user prompt, inputs the encrypted token to the encrypted LLM as described above and transmits the output data to the electronic apparatus 100. The electronic apparatus 100 decrypts the encrypted token and identifies whether the decrypted data is the general token or the control token.

The processor 130 of the electronic apparatus 100 controls the display 140 to display the response corresponding to the decrypted data when the decrypted data corresponds to the general token. FIG. 3 illustrates a state in which the response “Hello. May I help you?” is displayed. In this response, “Hello,” “.,” “May,” “I,” “help,” and “you” each correspond to the general token. Accordingly, the processor 130 sequentially or in batches displays these general token responses. On the other hand, the “?” is followed by the EOS token. When the processor 130 identifies the EOS token, the processor 130 transmits the EOS token to the server device 200. Upon receiving the EOS token, the processor 230 of the server device 200 stops the operation of the encrypted LLM and waits for the input of the next user prompt.

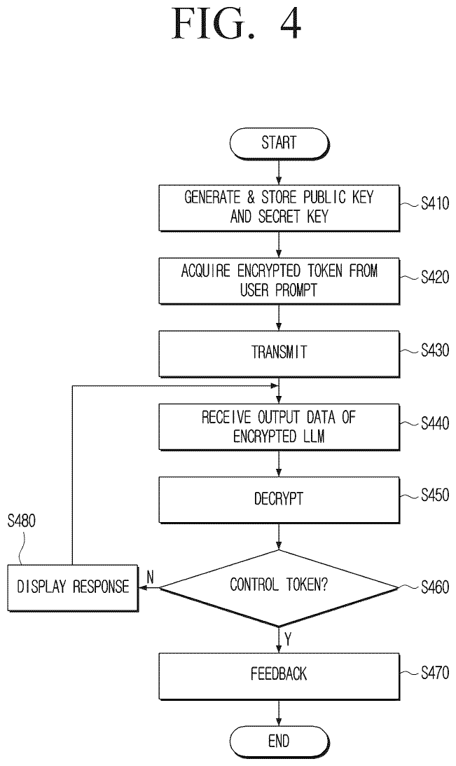

FIG. 4 is a flowchart for describing a method for providing a service of an electronic apparatus according to at least one embodiment of the present disclosure.

Referring to FIG. 4, the electronic apparatus generates a public key and a secret key for homomorphic encryption and stores the public key and the secret key in the memory (S410). Since the method for generating a public key and a secret key has been described above, a detailed description thereof will be omitted.

When the user prompt is input, the electronic apparatus tokenizes the user prompt by dividing the user prompt into tokens in preset units and homomorphically encrypts each token with the public key to acquire the encrypted token (S420). The electronic apparatus transmits the encrypted token to the server device in which the encrypted LLM is stored (S430).

Thereafter, when the output data of the encrypted LLM of the server device is received (S440), the electronic apparatus decrypts the received output data using the secret key (S450).

When the decrypted data corresponds to the control token, the electronic apparatus transmits the control token to the server device (S470). The electronic apparatus may identify whether the token is the control token or the general token based on the dictionary data stored in the memory. When the identified token is the general token, the electronic apparatus may display the response corresponding to the general token (S480).

When the identified token is the EOS token among the control tokens, the electronic apparatus may transmit the output stop instruction to the server device. Specifically, the electronic apparatus may execute an event handler to transmit the output stop instruction. However, the electronic apparatus is not limited thereto, and may transmit the EOS token itself to the server device.

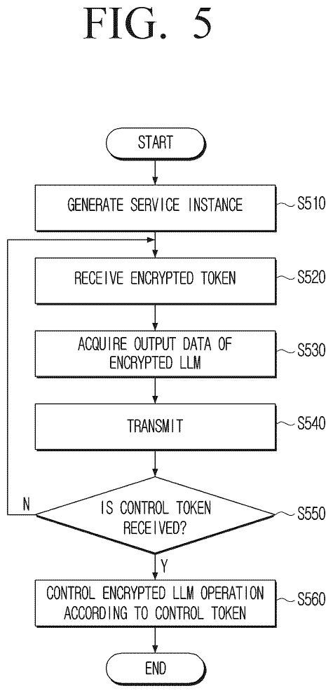

FIG. 5 is a flowchart for describing a method for providing a service of a server device according to at least one embodiment of the present disclosure.

Referring to FIG. 5, when the public key for the homomorphic encryption is received from the electronic apparatus, the server device generates the service instance corresponding to the electronic apparatus that has transmitted the public key (S510).

Thereafter, when the encrypted token is received from the electronic apparatus (S520), the server device inputs at least one encrypted token to the encrypted LLM to acquire the output data (S530). The encrypted token is a homomorphically encrypted ciphertext obtained after the user prompt, input to the electronic apparatus, is divided into preset units.

The server device transmits the output data of the encrypted LLM to the electronic apparatus (S540). The server device repeatedly performs an inference operation using the encrypted LLM until the control token is received, and may continuously stream the output data to the electronic apparatus. Since the LLM inference is performed in the encrypted state, the output data may also be in the form of the encrypted token.

Subsequently, when the control token is received from the electronic apparatus (S550), the server device controls the operation of the encrypted LLM based on the control token (S560).

For example, when the control token is the end of sequence (EOS) token, the use of the encrypted LLM is terminated. When the control token is a token for operation control rather than the EOS token, the server device selectively branches multiple generation models constituting the encrypted LLM based on the contents of the control token and performs the inference operation to acquire the output data.

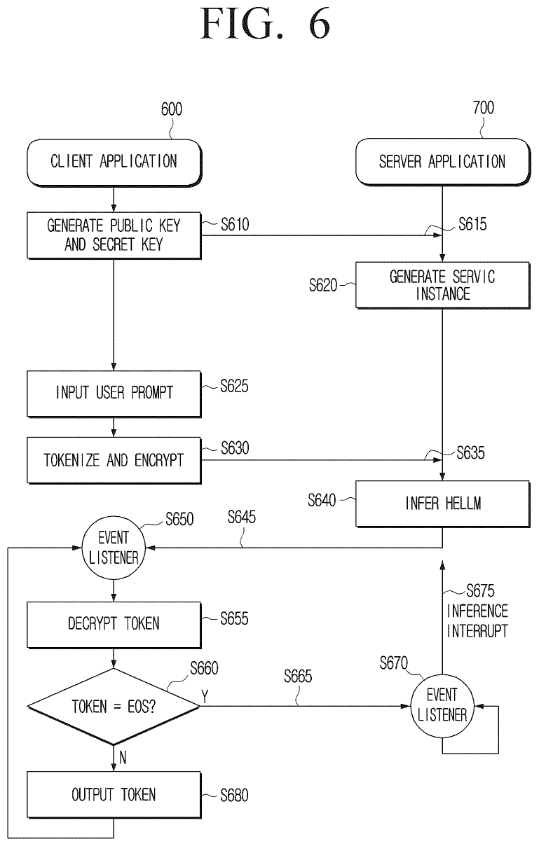

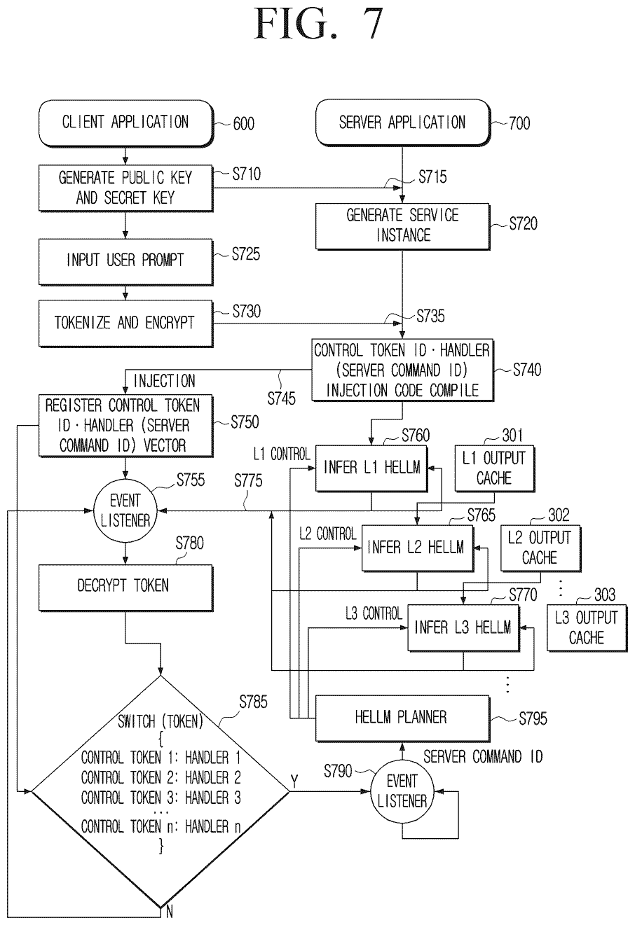

FIGS. 6 and 7 are timing diagrams for describing the operations of the electronic apparatus and the server device according to at least one embodiment of the present disclosure.

Specifically, FIGS. 6 and 7 illustrate a linked operation between a client application 600 installed on the electronic apparatus 100 and a server application 700 installed on the server device 200.

Referring to FIG. 6, the client application 600 generates the secret key and the public key (S610) and then transmits the public key to the server device (S615).

The server application 700 generates the service instance corresponding to the electronic apparatus (S620).

When any user of the electronic apparatus inputs the user prompt (S625), the client application 600 sequentially tokenizes and homomorphically encrypts the user prompt to generate multiple encrypted tokens (S630) and transmits the generated encrypted tokens to the server device (S635).

The server application 700 inputs the encrypted tokens to the encrypted LLM to acquire the output data (S640). This operation may be referred to as HELLM inference in the present disclosure.

The server application 700 transmits the inference result, i.e., the output data, to the electronic apparatus (S645).

When an event listener program installed on the electronic apparatus identifies the receipt of the output data (S650), the client application 600 decrypts the output data input by using the secret key (S655) to acquire the token in the plaintext form.

When the token is the EOS token (S660), the client application 600 transmits the EOS token or the corresponding output stop instruction to the server application 700 (S665).

When the event listener program installed on the server device identifies the receipt of the EOS token (S670), the server application 700 stops the inference operation of the encrypted LLM (S675).

When the token is not the control token but the general token, the client application 600 outputs the response corresponding to the token through the display (S680).

FIG. 7 is a timing diagram for describing in more detail the contents of FIG. 6.

Referring to FIG. 7, the client application 600 generates the secret key and the public key (S710) and then transmits the public key to the server device (S715).

The server application 700 generates the service instance corresponding to the electronic apparatus (S720). When the user of the electronic apparatus inputs the user prompt (S725), the client application 600 sequentially tokenizes and homomorphically encrypts the user prompt to generate multiple encrypted tokens (S730) and transmits the generated encrypted tokens to the server device (S735).

The server application 700 compiles the injection code for injecting the available control token and handler into the electronic apparatus, depending on the type of service provided by the server device (S740), and transmits the injection code to the electronic apparatus (S745). To protect the service IP, the server application 700 may hash the control token ID to be injected into the electronic apparatus and the command ID invoked by the corresponding handler.

Additionally, depending on the service type, the customized preprocessing module may be transmitted to the electronic apparatus for injection, or update data for dictionary data may be transmitted for updating.

The client application 600 stores data regarding the control token ID, the handler, etc., based on the transmitted injection code (S750). To protect the service IP, the control token ID, the command ID invoked by the corresponding handler, etc., may be hashed.

In FIG. 7, the operations of generating, transmitting, and storing injection code (S740, S745, S750) are illustrated as being performed after the transmission of the encrypted token; however, the present invention is not limited thereto, and such operations may be performed in advance.

The server application 700 inputs the received encrypted token to the encrypted LLM to acquire the output data. When the encrypted LLM includes multiple generation models composed of multiple layers, if the first encrypted token is received, the server application 700 performs the LLM inference using the generation model of the first layer (S760). The inference result is stored in the output cache 301 corresponding to the first layer and transmitted to the electronic apparatus (S775).

When the event listener program installed on the electronic apparatus identifies the receipt of the output data (S755), the client application 600 decrypts the output data input by using the secret key (S780) to acquire the token in the plaintext form.

When the acquired token is the control token (S785), the client application 600 transmits the control token or the corresponding control signal to the server application 700.

When the event listener program installed on the server device identifies the receipt of the control token or the control signal corresponding to the contents of the control token (S790), the server application 700 controls the operation of the encrypted LLM based on the control token (S795).

Specifically, the client application 600 repeatedly performs the inference by switching the branches for the generative model to be used in subsequent layers after the first layer and inputting the output data stored in the output caches 301, 302, 303, etc., for the previous layer to the branched generative model (S760, S765, S770).

Therefore, while verifying the encrypted LLM output in the encrypted state, it is possible to set and control the encrypted LLM according to various control codes.

According to the method for providing a service, various services, such as code writing and image generation, may be provided while maintaining security using the encrypted LLM.

The above describes an embodiment in which the control codes other than the EOS code are identified and transmitted to the server device. However, to ensure fail-safe service, the implementation may be implemented to restrictively determine whether the encrypted output data is EOS (or an equivalent operation termination mark). Furthermore, the maximum length of the output data may be previously limited to ensure the fail-safe service.

The above methods for providing a service may be performed by the electronic apparatuses and server devices illustrated in FIG. 2, but are not necessarily limited thereto, and may also be performed by other electronic apparatuses with various additional or modified configurations.

Also, various embodiments of the present disclosure have been described in detail above, each embodiment need not be implemented solely in isolation and may be implemented partially or fully in conjunction with other embodiments.

Meanwhile, methods according to at least some of the various embodiments of the present disclosure described above may be implemented in the form of applications that may be installed on existing electronic apparatuses. Additionally, the methods according to at least some of the various embodiments of the present disclosure described above may be implemented only with a software upgrade or a hardware upgrade for an existing electronic apparatus or server device.

Meanwhile, according to an embodiment of the disclosure, various embodiments described above may be implemented by software including instructions stored in a machine-readable storage medium (for example, a computer-readable storage medium). A machine may be an apparatus that invokes the stored instruction from the storage medium and may be operated depending on the invoked instruction, and may include the electronic apparatus (for example, the electronic apparatus A) according to the disclosed embodiments. In the case in which a command is executed by the processor, the processor may directly perform a function corresponding to the command or other components may perform the function corresponding to the command under a control of the processor. The command may include codes created or executed by a compiler or an interpreter. The machine-readable storage medium may be provided in a form of a non-transitory-readable storage medium. Here, the ‘non-transitory-readable storage medium’ means that the storage medium is a tangible device, and does not include a signal (for example, electromagnetic waves), and the term does not distinguish between the case where data is stored semi-permanently on a storage medium and the case where data is temporarily stored thereon. For example, the “non-transitory-readable storage medium” may include a buffer in which data is temporarily stored.

According to an embodiment, the methods according to the diverse exemplary embodiments disclosed in the present document may be included and provided in a computer program product. The computer program product may be traded as a product between a seller and a purchaser. The computer program product may be distributed in the form of a machine-readable storage medium (for example, compact disc read only memory (CD-ROM)), or may be distributed (for example, download or upload) through an application store (for example, Play Store™) or may be directly distributed (for example, download or upload) between two user devices (for example, smartphones) online. In a case of the online distribution, at least some of the computer program products (for example, downloadable app) may be at least temporarily stored in a machine-readable storage medium such as a memory of a server of a manufacturer, a server of an application store, or a relay server or be temporarily created.

Although exemplary embodiments of the present disclosure have been illustrated and described hereinabove, the present disclosure is not limited to the abovementioned specific exemplary embodiments, but may be variously modified by those skilled in the art to which the present disclosure pertains without departing from the gist of the present disclosure as disclosed in the accompanying claims. These modifications should also be understood to fall within the scope and spirit of the present disclosure.

1. An electronic apparatus, comprising:
a communication interface;
a memory; and
a processor,
wherein the processor is configured to generate a public key and a secret key for homomorphic encryption and store the generated public key and secret key in the memory,
when a user prompt is input, divide the user prompt into tokens in preset units, homomorphically encrypt the tokens using the public key, transmit the encrypted tokens to a server device storing an encrypted large language model (LLM) through the communication interface,
when output data of the encrypted LLM is received from the server device in response to the input of the encrypted token, decrypt the output data using the secret key, and
when the decrypted data corresponds to a control token, transmit the control token to the server device through the communication interface.

2. The electronic apparatus as claimed in claim 1, further comprising:
a display,
wherein, when the decrypted data corresponds to a general token, the processor is configured to control the display to display a response corresponding to the decrypted data.

3. The electronic apparatus as claimed in claim 1, wherein the memory stores dictionary data, and
the processor is configured to identify a token corresponding to the decrypted data based on the dictionary data,
when the identified token is an end of sequence (EOS) token, transmit an output stop instruction to the server device through the communication interface,
when the identified token is a control token other than the end of sequence (EOS) token, transmit the control token to the server device through the communication interface, and
when the identified token is a general token, control the display to display a response corresponding to the general token.

4. A server device, comprising:
a communication interface;
a memory storing an encrypted LLM; and
a processor,
wherein the processor is configured to, when a public key for homomorphic encryption is received through the communication interface, generate a service instance corresponding to an electronic apparatus transmitting the public key,
when tokens homomorphically encrypted by dividing a user prompt input to the electronic apparatus in preset units are received through the communication interface,
input at least one of the encrypted tokens to the encrypted LLM to acquire output data, transmit the output data to the electronic apparatus through the communication interface, and
when a control token is received from the electronic apparatus through the communication interface, control an operation of the encrypted LLM based on the control token.

5. The server device as claimed in claim 4, wherein the processor is configured to terminate the use of the encrypted LLM when the control token received from the electronic apparatus is an end of sequence (EOS) token.

6. The server device as claimed in claim 5, wherein the encrypted LLM includes a plurality of generation models, and
the processor is configured to execute a service corresponding to the control token when the control token received from the electronic apparatus is a token for operation control rather than the EOS token.

7. The server device as claimed in claim 5, wherein the processor is configured to compile an injection code for injecting an available control token and handler into the electronic apparatus according to a type of service provided by the server device, and transmit the injection code to the electronic apparatus through the communication interface.

8. A method of providing a service of an electronic apparatus, comprising:
generating a public key and a secret key for homomorphic encryption and storing the generated public key and secret key in the memory;
when a user prompt is input, dividing the user prompt into tokens in preset units and homomorphically encrypting the tokens using the public key;
transmitting the homomorphically encrypted tokens to a server device storing an encrypted large language model (LLM) and receiving output data of the encrypted LLM from the server device in response to the input of the encrypted token;
decrypting the received output data using the secret key; and
when the decrypted data corresponds to a control token, transmitting the control token to the server device.

9. The method as claimed in claim 8, further comprising:
identifying a token corresponding to the decrypted data based on the dictionary data stored in the memory; and
when the identified token is a general token, displaying a response corresponding to the general token.

10. The method as claimed in claim 9, wherein the transmitting of the control token to the server device includes:
when the identified token is an end of sequence (EOS) token, transmitting an output stop instruction to the server device; and
when the identified token is a control token other than the end of sequence (EOS) token, transmitting the control token to the server device.

11. A method of providing a service of a server device, comprising:
when a public key for homomorphic encryption is received from an electronic apparatus, generating a service instance corresponding to an electronic apparatus transmitting the public key;
when a user prompt input to the electronic apparatus is divided in preset units and then homomorphically encrypted tokens are received, inputting at least one of the encrypted tokens to an encrypted LLM to acquire output data;
transmitting the output data to the electronic apparatus; and
when a control token is received from the electronic apparatus, controlling an operation of the encrypted LLM based on the control token.

12. The method as claimed in claim 11, wherein, in the controlling of the operation of the encrypted LLM, when the control token received from the electronic apparatus is an end of sequence (EOS) token, the use of the encrypted LLM is terminated.

13. The method as claimed in claim 12, wherein, in the controlling of the operation of the encrypted LLM, when the control token received from the electronic apparatus is a token for operation control rather than the EOS token, a service corresponding to the control token is executed.

14. The method as claimed in claim 12, further comprising:
compiling an injection code for injecting an available control token and handler into the electronic apparatus according to a type of service provided by the server device; and
transmitting the injection code to the electronic apparatus.

15. A non-transitory-readable recording medium storing a program for executing a method for providing a service of an electronic apparatus,
wherein the method for providing a service includes:
generating a public key and a secret key for homomorphic encryption and storing the generated public key and secret key in memory of the electronic apparatus;
when a user prompt is input, dividing the user prompt into tokens in preset units and homomorphically encrypting the tokens using the public key;
transmitting the homomorphically encrypted tokens to a server device storing an encrypted large language model (LLM);
when output data of the encrypted LLM is received from the server device in response to the input of the encrypted token, decrypting the received output data using the secret key; and
when the decrypted data corresponds to a control token, transmitting the control token to the server device.
